(19) United States
(12) Patent Application Publication
(10) Pub. No.: US 2022/0052986 A1
(43) Pub. Date: Feb. 17, 2022

(54) Secure Video Conferencing System For A Meeting Room

(71) Applicant: Plantronics, Inc., Santa Cruz, CA (US)

(72) Inventor: Cary Arnold Bran, Vashon, WA (US)

(73) Assignee: Plantronics, Inc., Santa Cruz, CA (US)

(21) Appl. No.: 16/994,508

(22) Filed: Aug. 14, 2020

(51) Int. Cl. H04L 29/06; H04L 12/18

(52) U.S. Cl. CPC H04L 63/0428; H04L 12/1822; H04L 65/4015; H04L 12/1818; H04L 12/1827

(57) ABSTRACT

A secure video conferencing system for a meeting room is discussed. The secure video conferencing system comprising a camera for capturing video of at least one writing board in the meeting room and to provide video data thereof; and processing circuitry, connected at least with the camera to receive the video data. The processing circuitry is configured to determine a change in room occupancy of the meeting room and to detect user content on the at least one writing board using the video data. The processing circuitry is further configured to provide a security notification if upon the determination of the change in room occupancy, user content is present on the at least one writing board.

### FIELD

The present disclosure relates generally to the field of video conferencing for meeting rooms and in particular to a video conferencing system with improved security.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Video conferencing systems, also sometimes referred to as videotelephony systems or telepresence systems, are ubiquitous today for office spaces and meeting/conference rooms. Such systems may comprise at least a camera, a microphone, a video screen, and speakers. These devices are usually somewhat permanently installed in the respective meeting room and may be connected to a central unit, which handles the incoming and outgoing video and audio streams to one or multiple remote conferencing participants.

Group collaboration today is largely conducted using meeting rooms equipped with such video conferencing systems, for example due to globalized teams working together, but also due to the fact that an increasing number of businesses/companies embrace an ‘open office environment’ that provides a decreased number of enclosed offices for employees. Because of the noisy nature of the open office environment, group collaboration, when it occurs, is often forced into the meeting rooms available to the company.

Many meeting rooms comprise some sort of writing board, i.e., a temporarily or permanently installed writing surface that allows meeting participants to write on and share thoughts, data, diagrams, etc., with other local and/or remote meeting participants. One more commonly used example of a writing board is the whiteboard.

It is not uncommon for the writing board to be used to develop sensitive corporate information of a business, such as trade secrets, organizational strategies, corporate strategies, engineering diagrams, etc.

While a valuable tool for enterprise collaboration, a writing board installed in a meeting room persists what is drawn on it and it is up to the meeting participants to erase sensitive information on it when the meeting concludes. However, erasing can be forgotten easily, leaving sensitive or confidential information available in an unsecured environment for all to see. Furthermore, it is possible that a following video conference in the same meeting room ‘leaks’ the information on the writing board to an unintended remote meeting participant, such as clients of the respective business, vendors, or even competitors.

Based on the above, an object exists to provide a secure video conferencing system for meeting rooms, in particular meeting rooms that are equipped with a writing board.

### SUMMARY

The object is solved by the subject matter of the independent claims. The dependent claims and the following description describe various embodiments of the invention.

In general and in one exemplary aspect, a secure video conferencing system for a meeting room is provided. The secure video conferencing system of this aspect comprises at least a camera for capturing video of at least one writing board in the meeting room and to provide video data thereof. The secure video conferencing system further comprises processing circuitry, connected at least with the camera to receive the video data. In the present exemplary aspect, the processing circuitry is configured to determine a change in room occupancy of the meeting room. The processing circuitry is further configured to detect user content on the at least one writing board using the video data. The processing circuitry is further configured to provide a security notification if upon the determination of the change in room occupancy, user content is present on the at least one writing board.

In another exemplary aspect, processing circuitry for a video conferencing system for a meeting room is provided, wherein the processing circuitry is connectable at least with a camera of the video conferencing system to receive video data; the processing circuitry is configured to determine a change in room occupancy of the meeting room and to detect user content on at least one writing board in the meeting room using the video data; and wherein the processing circuitry is further configured to provide a security notification if upon the determination of the change in room occupancy, user content is present on the at least one writing board.

In another exemplary aspect, a method of operating a secure video conferencing system for a meeting room is provided, wherein the secure video conferencing system comprises at least a camera for capturing video of at least one writing board in the meeting room and to provide video data thereof; the method comprising the steps of:

determining, using the video data, a change in room occupancy of the meeting room;

detecting user content on the at least one writing board using the video data; and

providing a security notification if upon the determination of the change in room occupancy, user content is present on the at least one writing board.

The details of one or more embodiments are set forth in the accompanying drawings and the description below. Other features will be apparent from the description, drawings, and from the claims.

### DESCRIPTION OF DRAWINGS

FIG. 1 shows an exemplary embodiment of a secure video conferencing system in a schematic block diagram;

FIG. 2 shows a schematic diagram of the exemplary embodiment of FIG. 1 installed in a meeting room; and

FIG. 3 shows an exemplary flow diagram of processing circuitry of the video conferencing system of FIG. 1

### DETAILED DESCRIPTION

Specific embodiments of the invention are here described in detail, below. In the following description of embodiments of the invention, the specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In the following explanation of the present invention according to the embodiments described, the terms “connected to” or “connected with” are used to indicate a data, video, and/or audio (signal) connection between at least two components, devices, units, processors, circuits, or modules. Such a connection may be direct between the respective components, devices, units, processors, circuits, or modules; or indirect, i.e., over intermediate components, devices, units, processors, circuits, or modules. The connection may be permanent or temporary; wireless or conductor based; digital or analog.

For example, a data, video, and/or audio connection may be provided over a direct connection, a bus, or over a network connection, such as a WAN (wide area network), LAN (local area network), PAN (personal area network), BAN (body area network) comprising, e.g., the Internet, Ethernet networks, cellular networks, such as LTE, Bluetooth (classic, smart, or low energy) networks, DECT networks, ZigBee networks, and/or Wi-Fi networks using a suitable communications protocol. In some embodiments, a USB connection, a HDMI connection, a HDCI connection, a Bluetooth network connection, a Wi-Fi connection, and/or a LAN connection is used to transmit video, audio and/or data.

In the following description, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between like-named elements. For example, a first element is distinct from a second element, and the first element may encompass more than one element and succeed (or precede) the second element in an ordering of elements.

In many business settings, meeting rooms with writing boards are commonly used for group collaboration. Such writing boards are in particular whiteboards, blackboards, chalkboards, flip charts, glass boards, easel pads, or writable walls. It is not uncommon for the writing board to be used to share sensitive or confidential information, such as for example but without limitation, trade secrets, organizational or corporate strategic data, revenue data, profit forecasts, business ideas, inventions, or engineering diagrams.

A problem may arise when sensitive information is left on the writing board when a meeting is over and the participants of the meeting leave. As the present inventor has ascertained, any other person having access to the meeting room could possibly take notice of the information that has been left on the writing board, thus allowing a potential ‘local information leak’. This may particularly be problematic in a co-working environment, where many businesses share common meeting rooms and thus it may easily be possible that the information is unintendedly disclosed to an external party.

Furthermore, in a meeting room with a conferencing system, the information that has been left on the writing board could potentially be disclosed to a remote meeting participant, thus allowing a potential ‘remote information leak’. This may be particularly problematic in case of a meeting with an external party, such as a vendor, client, or in some scenarios, even a competitor.

The present invention aims to increase the security of a meeting room with a writing board and to reduce the possibility of local and remote information leaks. In the context of the present discussion, the term ‘writing board’ is understood to comprise any writing surface that is temporarily or permanently installed in the meeting room and that can be used for writing, sketching, etc. For example, a writing board may for example be a whiteboard, blackboard, chalkboard, flip chart, glass board, easel pad, or a writable wall surface.

According to a first exemplary aspect, a secure video conferencing system for a meeting room is provided. The video conferencing system may be of any suitable type to capture and, e.g., transmit video and/or audio to at least one remote device of a remote conferencing participant, i.e., someone, who is not in the respective meeting room. It is noted that a remote conferencing participant may be a recording device in corresponding embodiments. The term ‘video conferencing system’ is used interchangeably herein with ‘videotelephony system’ and ‘telepresence system’.

The video conferencing system of this aspect may be configured to be temporarily or permanently installed in the meeting room, so that video and audio in the meeting room may be captured. It is noted that herein, the terms ‘meeting room’, ‘conference room’, ‘huddle room’, ‘huddle space’, ‘team room’, ‘board room’, and ‘conferencing room’ are used interchangeably for a dedicated enclosed space, usually in a building, structure, or vehicle. In some embodiments, the meeting room may be an office room or more broadly, office space.

The video conferencing system of this aspect system comprises at least: a camera for capturing video of at least one writing board in the meeting room and to provide video data thereof; and processing circuitry, connected at least with the camera to receive the video data. In some embodiments, the video conferencing system may comprise one or more microphones for capturing audio in the meeting room and to provide audio data to the processing circuitry.

The aforesaid camera(s), microphone(s), and processing circuitry may in some embodiments be formed integrated, e.g., in a common housing or enclosure. For example, the video conferencing system may be a ‘video bar’, e.g., one that has all or most of its components in a compact housing (see, e.g., the Poly Studio X family of the applicant). Alternatively or additionally, the system may be of ‘video all-in-one’ type, i.e., a single unit for video conferencing, writing/drawing (e.g., whiteboarding), and sharing documents. Alternatively and in some embodiments, at least some of the camera, the microphone, and the processing circuitry are formed separately from each other and may then be communicatively coupled, e.g., by suitable wireless or wire-based connections. For example, the processing circuitry may be provided separately from the camera and/or microphone to allow it to be installed in an equipment room, server room, or other location, which may be remote from the meeting room. In this example, accordingly, only the camera and microphone are physically arranged in the meeting room.

The camera and microphone may be of any suitable type. For example, the camera may be a high definition camera that, e.g., has a wide field of view. In some embodiments, the camera is a ‘content camera’ and/or is directed to only capture the at least one writing board.

The microphone may for example be of dynamic, condenser, electret, ribbon, carbon, piezoelectric, fiber optic, laser, or MEMS type. The microphone may be omnidirectional or bidirectional. In some embodiments, the microphone is a boundary microphone that, e.g., may be provided as a table-top unit for a corresponding conference table.

In some embodiments, the system comprises more than one camera and/or more than one microphone. The latter embodiments are particularly suitable for larger meeting rooms, where multiple cameras and/or microphones may be necessary to allow each local conferencing participant in the meeting room to participate in the video conference and to be adequately heard and seen by any remote conferencing participant. In some embodiments, multiple cameras are provided that capture video of multiple writing boards of the meeting room. In this case, typically so-called ‘content cameras’ are used. In some embodiments, the camera is a camera module that has multiple cameras. In some embodiments, the processing circuitry is configured to dynamically select a camera and/or microphone that captures the local conferencing participant who currently presents/talks.

In some embodiments, the multiple cameras spaced apart from each other in one or more directions to provide different view perspectives. For example, the system may include multiple cameras housed in or on a common camera housing or camera mount. Each camera may be set or controlled to capture a full area of a presentation environment/meeting room, or each camera may be set or controlled to capture different areas of the presentation environment/meeting room. Additionally or alternatively and in some embodiments, each camera may be controlled, e.g., panned, tilted, and/or zoomed, independent of each other camera.

In the video conferencing system of the present aspect, the processing circuitry is configured to determine a change in room occupancy. Thus, the processing circuitry may be configured to determine if a meeting has ended or a new meeting is about to start. The determination of a change in room occupancy may in some embodiments be conducted using the video data of the camera of the video conferencing system. Other embodiments for the determination of a change in room occupancy are discussed in the following. The term ‘change in room occupancy’ is understood broadly to a change of the meeting participants in the meeting room. For example, a change in occupancy may refer to a situation, where a meeting has ended and all meeting participants have left the meeting room. In another example, one or more meeting participants enter a previously empty meeting room. In both examples, a change in room occupancy refers to a change between an occupied room and an unoccupied room. In some embodiments, a change in room occupancy is determined from the schedule of the meeting room, e.g., by connecting with a suitable calendaring server or from a ‘hang-up event’ occurring in the video conferencing system, e.g., when a video conference is ended.

The processing circuitry is furthermore configured to detect user content on the at least one writing board using the video data of the camera. The term ‘user content’ herein refers broadly to any writing of a user on the writing board, for example, text, numbers, drawings, sketches, scribbles, designs, etc., but also any other user-created content, such as collages or designs on the writing board, for example using post-it notes, magnetic stickers/shapes, and/or photographs, without limitation.

According to the present exemplary aspect, in case a change in room occupancy is determined and user content on the writing board is detected, the processing circuitry is configured to provide a security notification. The security notification may be of any suitable type and may be output in the meeting room and/or at one or more locations, external thereof. For example, the security notification may be provided by e-mail, SMS, voicemail, or other modality. The security notification for example may be provided to one or more of the facilities management, the organizer of the meeting that booked the meeting room, e.g., by a lookup from a connected calendaring/scheduling system, and the last person that modified the whiteboard, e.g., by applying facial recognition on the video data and matching against a directory to lookup the contact information of that person. In any event, the security notification allows to take corrective action and, e.g., erase the writing board before starting another meeting in the respective meeting room.

The processing circuitry may be of any suitable type to conduct at least the aforesaid operation. For example, the processing circuitry may comprise a microprocessor with suitable programming in a memory to provide the functionality as discussed herein. Alternatively or additionally and in some embodiments, the processing circuitry may comprise hard-wired logic circuitry to provide the discussed functionality.

The video conferencing system according to the present aspect and in further embodiments certainly may comprise additional components. For example, the system in one exemplary embodiment may comprise additional control circuitry, additional circuitry to process audio and/or video, wireless or wired communications interfaces, a central processing unit, one or more housings, a mains power supply, battery, one or more video output devices, e.g., for incoming conference video, and/or one or more speakers, e.g., for incoming conference audio.

In some embodiments, the video conferencing system comprises a communication interface that is connected with the processing circuitry and adapted to transmit at least one of the video data and the audio data to at least one remote conferencing participant. In some embodiments, the communication interface is a network interface to connect to a LAN, WAN, and/or the Internet. In some embodiments, the processing circuitry controls the transmission of the video data and audio data to the at least one remote conferencing participant and/or the reception of video data and/or audio data from the at least one remote conferencing participant. In alternative embodiments, a transmission management processor provides the latter functionality, i.e., management of incoming and/or outgoing video/audio.

In some embodiments, the processing circuitry is configured to provide the security notification until it is detected that the user content is removed from the at least one writing board. The present embodiments provide a persistent notification until the potentially sensitive information on the writing board is removed, which may incentivize removal of the potentially sensitive information. The security notification may in some embodiments be provided permanently, e.g., on a video device in the meeting room. In some embodiments, the security notification is provided intermittently, for example when the meeting organizer is informed, as mentioned in the preceding. In the latter embodiments, the intermittent notification may be provided with an increase in frequency over time until the user content is removed.

In some embodiments, the secure video conferencing system further comprises one or more of a video device and a speaker, wherein the security message is provided in the meeting room with at least one of the video device and the speaker. The video device may be of any suitable type to provide video output in the meeting room, such as a display, TV screen, projector, system controller, video wall, etc. In some embodiments, the secure video conferencing system comprises one or more meeting room consoles that can be arranged outside of the meeting room. In such cases, the security notification may additionally be provided on the one or more meeting room consoles.

In some embodiments, the secure video conferencing system further comprises a communication interface, connected with the processing circuitry. In some embodiments, the communication interface being connectable to a network, wherein the security message is provided to one or more of a notification server, a calendaring server, and a room control system using the communication interface.

A provision of the security notification to the notification server allows, e.g., to easily inform for example the facilities management or the organizer of the meeting, as discussed in the preceding. A provision of the security notification to the calendaring server allows to block the meeting room in the respective schedule of the room, so that the meeting room is unbookable until the user content is removed. In the context of this discussion, a calendaring server may be for example a CalDAV server, a server running Microsoft® Exchange, or any other server that allows scheduling of meeting rooms. A provision of the security notification to a room control system allows the room control system to operate any installed privacy screens or smart glass films, so that the privacy screens may be closed or the smart glass films may be controlled opaque when user content is on the at least one writing board to reduce the chance for a local leak of people walking by the meeting room. In some embodiments, the room control system operates the doors to the meeting room and, e.g., locks the doors as necessary to reduce the chance of a local leak.

In some embodiments, the processing circuitry may be configured with hierarchy information, so that processing circuitry provides the security notification in dependence of the hierarchy information. In other words, the measures taken by the processing circuitry depend on the position of the meeting organizer or a meeting attendee in the respective organization.

For example, if the meeting was organized or attended by the CEO of the organization, the security notification may be sent to the room control system to lock the doors to the meeting room and to the notification server to inform the CEO's office that the removal of user content is required. The room control system then can be programmed that only the staff of the CEO's office can access the room by programming a key card reader at the meeting room door accordingly.

If the meeting instead was organized by a mid-level manager, the security notification is sent instead only to the notification server, so that facilities management is informed that removal of the user content from the at least one writing board is necessary, but without the more restrictive measure of locking the door to the meeting room.

In some embodiments, the processing circuitry is configured with an escalation schedule, so that processing circuitry provides the security notification in dependence of the escalation schedule.

The escalation schedule may comprise one or more sets of notification actions to be taken based on the time that has passed since the user content has been detected upon the detection of the change in room occupancy, i.e., the time passed since the first detection time. In a simple embodiment, the escalation schedule provides that the frequency of security notifications is increased with an increase in time passed. In another alternative or additional embodiment, the notification is changed with increasing time passed. For example, the escalation schedule may provide that first, the security notification is provided first in the meeting room only, then after some time (e.g., after 10 minutes), the security notification is provided to the meeting organizer, and at last (e.g., after 30 minutes), the security notification is provided to the facilities management while at the same time, the meeting room is set unbookable using the calendaring server. In some embodiments, the escalation schedule may provide that the notification frequency is increased based upon the next scheduled meeting. For example, if the escalation schedule is invoked and a scheduled meeting is on the calendar in a defined time period, e.g., 30 minutes, the timing for the escalation path may be truncated, or depending on configuration, the escalation schedule may provide to ‘leapfrog’ the escalation chain directly to the highest level.

In some embodiments, the processing circuitry is further configured to block the initiation of a video conference when the security notification is provided. The present embodiments reduce the chance for a remote leak until the user content is removed from the at least one writing board.

Additionally and in some embodiments, the processing circuitry is configured so that an initiation of the video conference is allowed even while the security notification is provided. The processing circuit in these embodiments are configured to check for a ‘user override’. The present embodiments allow to initiate the video conference even when user content is present on the at least one writing board if the meeting participants expressly acknowledge the associated risk by the user override, which, e.g., may be entered using a controller of the video conferencing system. In some embodiments, upon a user override, the processing circuitry configures the video conferencing system to process the video steam so that the at least one writing board is blurred in the outgoing video stream that is sent to at least one remote meeting participant. In some embodiments, upon a user override, the processing circuitry configures the video conferencing system to restrict the use of eventually present content cameras that would otherwise provide video of the at least one writing board to the remote meeting participant(s).

In some embodiments, the secure video conferencing system comprises a memory interface, coupled with the processing circuitry, wherein in case a change in room occupancy is determined and user content is present on the at least one writing board, the memory interface is configured to store one or more images of the at least one writing board.

In other words, the memory interface allows to obtain one or more images of the at least one writing board before the user content is subsequently removed. This is useful in case the user content needs to be reconstituted. The respective one or more images may in some embodiments be stored in a corresponding content memory, which for example may be a RAM, SSD, HDD, or any other suitable memory. The content memory may for example be provided as a component of the secure video conferencing system. Alternatively or additionally, the content memory may be provided as a network or cloud storage. In this case, the one or more images are transmitted using the communication interface.

In some embodiments, the processing circuitry is configured not to provide the security notification in case a clearance indicator is detected in the video data, for example on the at least one writing board or at a different location in the meeting room. The present embodiments allow meeting participants to provide a marking, e.g., on the at least one writing board, that indicates that the information on the at least one writing board is not sensitive and can safely remain after the meeting. In some embodiments, the presence of the clearance indicator may be detected by the processing circuitry when the words “leave” or “do not erase” are determined on the at least one writing board. The processing circuitry may in such case for example be equipped with an optical character recognition (OCR) circuit.

In some embodiments, the processing circuitry is configured so that if the clearance indicator has been detected, it will adapt its security notification messaging and/or frequency.

In some embodiments, the processing circuitry may also keep track of the content and length of time that the whiteboard has been occupied with content and if the content has not changed for a predetermined time period, the processing circuitry will adapt its security notification messaging and/or frequency. In some embodiments, the processing circuitry in this case will provide the security notification with an increased frequency and/or if there is a predefined escalation schedule, it will escalate the message.

For example, a situation may be provided where someone ‘parks’ their scribblings on a writing board with a clearance indicator for weeks or months at a time. In addition to posing a potential security risk, it also blocks others from using the writing board.

In some embodiments, the processing circuitry stores an image of the last person who modified the white board so that it is possible to determine the person responsible for cleaning up the writing board and also to know the author of the respective user content.

In some embodiments, the processing circuitry is configured to capture an image of the person who changed the writing board last and then either use facial recognition to determine who was the last person to change the content or send that image along to the recipients of the escalation messages or building management.

In some embodiments, the change in room occupancy is determined by the processing circuitry using one or more of the camera and a room occupancy detector. In the context of this explanation, a room occupancy detector may be of any suitable type for determining the change in room occupancy. For example, the room occupancy detector may be an infrared motion detector, a microwave (radar) motion detector, an ultrasonic motion detector, a tomographic motion detector, or a further camera. In some embodiments, more than one room occupancy detectors are used.

The room occupancy detector may be provided as a component of the secure video conferencing system or separately thereof. In any event, the room occupancy detector is communicatively coupled to the processing circuitry.

In some embodiments, the processing circuitry is configured to determine user content on the at least one writing board by object detection. In the context of object detection and in some embodiments, the processing circuitry may be trained to determine the user content by its optical characteristic or the difference in the image between an empty writing board and a writing board with user content. For example, the ‘YOLO v3’ algorithm may be used to determine the user content from the video data.

In some embodiments, the processing circuitry is configured to determine a change in room occupancy by object detection. Similarly to the preceding embodiments, the processing circuitry may be adapted to determine a change in room occupancy by object detection, e.g., by detecting one or more persons in the room. Also here, the ‘YOLO v3’ algorithm may be used. (further alternative would be to just go by calendaring data or a mix thereof) The present embodiments may be used instead of or in conjunction with determining the room occupancy from the meeting room's schedule, as discussed in the preceding.

In some embodiments, the processing circuitry is configured to determine a change in room occupancy of the meeting room and to detect user content on the at least one writing board in predefined intervals. Determining the change in room occupancy and/or detecting the user content in predefined intervals helps reduce the necessary computing power, compared with a continuous determination. For example, a suitable interval may be in the range of 10-30 seconds.

In some embodiments, the processing circuitry is configured with a predefined detection zone around the at least one writing board. In the present embodiment, the processing circuitry additionally may be configured to detect user content and/or determine a change in room occupancy once a person is detected in the detection zone in predefined intervals, e.g., every 10-30 seconds.

In another exemplary aspect, processing circuitry for a video conferencing system for a meeting room is provided, wherein the processing circuitry being connectable at least with a camera of the video conferencing system to receive video data. In some embodiments, the processing circuitry is configured to determine a change in room occupancy of the meeting room and to detect user content on at least one writing board in the meeting room using the video data. In some embodiments, the processing circuitry is further configured to provide a security notification if upon the detection of the change in room occupancy, user content is present on the at least one writing board.

In some embodiments, the processing circuitry according to the present aspect is configured according to one or more of the embodiments, discussed in the preceding with respect to the preceding aspect(s). With respect to the terms used and their definitions, reference is made to the preceding aspect(s).

In another exemplary aspect, a method of operating a video conferencing system for a meeting room is provided. Herein, the secure video conferencing system comprises at least one of a camera for capturing video of at least one writing board in the meeting room and to provide video data. The method comprises the steps of:

determining, using the video data, a change in room occupancy of the meeting room;

detecting user content on the at least one writing board using the video data; and

providing a security notification if upon the determination of the change in room occupancy, user content is present on the at least one writing board.

In some embodiments, the method steps are conducted by processing circuitry of the video conferencing system. In some embodiments, a (e.g., non-transitory) computer-readable medium is provided with contents that are configured to cause a video conferencing system or processing circuitry for a video conferencing system to conduct the method steps.

In some embodiments, the video conferencing system according to the present aspect is configured according to one or more of the embodiments, discussed in the preceding with respect to the preceding aspect(s). With respect to the terms used and their definitions, reference is made to the preceding aspect(s).

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate figures. It is further noted that the figures are schematic and provided for guidance to the skilled reader and are not necessarily drawn to scale. Rather, the various drawing scales, aspect ratios, and numbers of components shown in the figures may be purposely distorted to make certain features or relationships easier to understand.

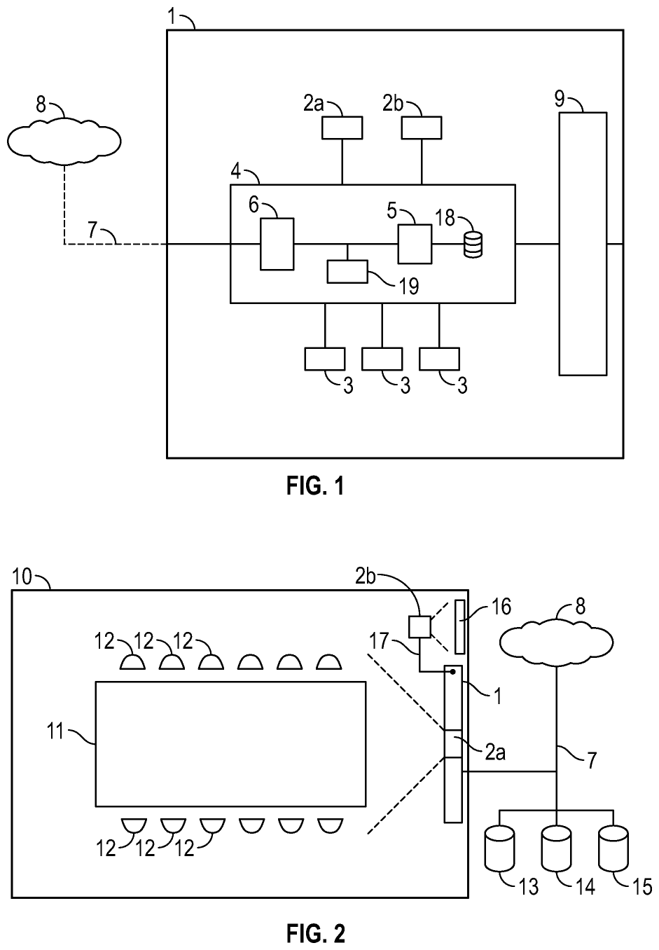

FIG. 1 shows an exemplary embodiment of a secure video conferencing system 1 according to the invention in a schematic block diagram, in the following also referred to as ‘system’ for simplicity.

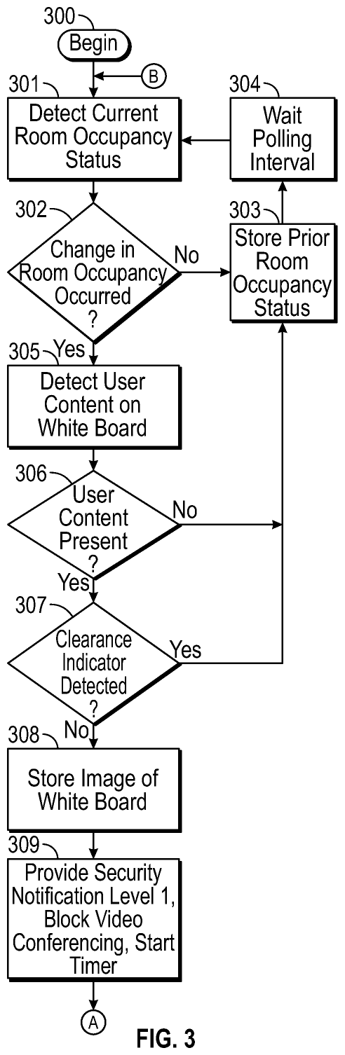

The system 1 comprises two cameras 2a, 2b. Camera 2a is a high-definition 1080p camera, arranged to capture meeting room 10 (see FIG. 2) Camera 2b is a content camera that captures at least one whiteboard 16 (see FIG. 2). It is noted that instead of whiteboard 16, a different type of writing board may be used, as for example a blackboard, a chalkboard, a flip chart, a glass board, an easel pad, a sticky note (pad), or a writable wall surface.

The system 1 furthermore comprises three microphones 3 that form an adaptive beamforming microphone array to capture presenting/speaking local meeting participants, i.e., persons in the meeting room 10. The cameras 2a, 2b and the microphones 3 are connected to system controller 4, which comprises processing circuitry 5, a network interface 6, a touchpad display/controller 19, and memory 18. The interface may connect to a LAN 7, so that a conference with at least one remote meeting participant (i.e., not in meeting room 10) can be conducted over the Internet 8. The system controller 4 is furthermore connected to a video screen 9, which comprises a display and speaker to show incoming audio/video streams from the at least one remote meeting participant to the local meeting participants in the meeting room 10.

The system controller 4 handles the reception and transmission of audio/video streams between the system 1 and the at least one remote meeting participant. The system controller 4 comprises a microprocessor and memory (both not shown) with a suitable programming to provide the corresponding audio/video stream transmission and reception functionality. In this embodiment, the microprocessor may be a Qualcomm Snapdragon 835 for example.

The processing circuitry 5 is configured to determine a change in room occupancy of the meeting room 10 and also to detect user content on the whiteboard 16. If the change in room occupancy of the meeting room 10 is determined while content is present on the whiteboard 16, a security notification is provided by the processing circuitry 5, as is discussed in more detail in the following. The functionality of circuitry 5 in the present embodiment is provided when executing corresponding software, stored in the memory of system controller 4, on the microprocessor of the system controller 4. Alternatively or additionally, it is possible to provide at least a part of the functionality of at least the processing circuitry 5 by dedicated hardware.

FIG. 2 shows a schematic top view of meeting room 10 with the video conferencing system 1 installed therein. The meeting room 10 comprises a conference table 11 with multiple chairs 12. As can be seen from FIG. 2, the secure video conferencing system 1 is connected to LAN 7 and Internet 8 to allow conducting video conferences with remote meeting participants. In the embodiment of FIG. 2, a notification server 13, a calendaring server 14, and a room control system 15 are connected to LAN 7 and thus to the secure video conferencing system 1. Content camera 2b is mounted on on an articulating extension arm 17, so that content camera 2b can be positioned in front of whiteboard 16. Content camera 2b should be positioned higher than whiteboard 16, so that the local meeting participants can see the whiteboard 16 freely.

As discussed in the preceding, processing circuitry 5 of video conferencing system 1 is configured to determine a change in room occupancy of the meeting room 10 and also to detect user content on the whiteboard 16. If both, the change in the room occupancy is determined and user content on the whiteboard 16 is detected, a security notification is provided by the processing circuitry 5. The security notification serves as an indication that a meeting in meeting room 10 has ended or a new meeting is about to begin, which may cause an unintended ‘leak’ of the potentially sensitive or confidential user content to the participants (local and/or remote) of the next meeting in the meeting room.

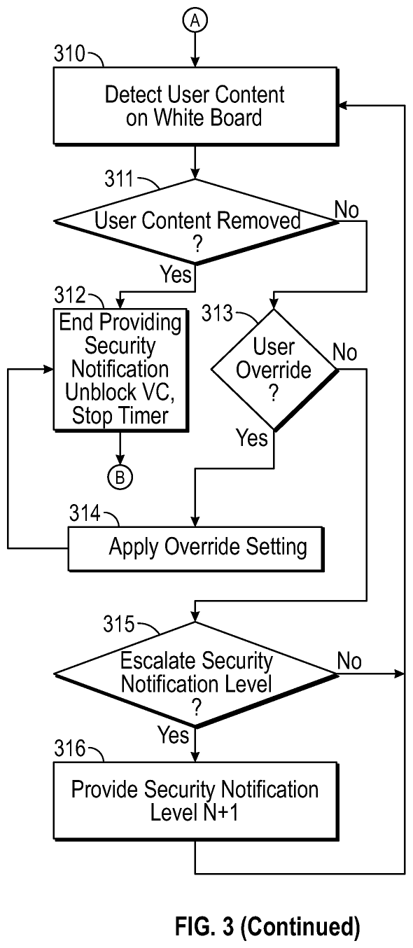

An embodiment of the operation of processing circuitry 5 is in the following discussed with reference to the flow diagram of FIG. 3. The operation of the processing circuitry 5 begins in step 300 with the activation of system 1, e.g., when system 1 is connected with power or upon booting up system 1.

In step 301, the processing circuitry 5 detects the current room occupancy status. In the context of the present embodiment, the current room occupancy status is indicative, whether at least one person is in the meeting room 10 or not, or in other words, whether the meeting room 10 is occupied or unoccupied. Processing circuitry 5 in the present embodiment in step 301 analyses video images, obtained from high-definition camera 2a and applies an object detection algorithm to the video images. In the present embodiment, the object detection algorithm is YOLO v3, which is trained to detect persons, i.e., meeting participants in the meeting room 10, to determine the current room occupancy status. Alternatively or additionally, a variety of ML based techniques that could be used in this step, such as Single Shot Detection MobileNet (example: https://www.pyimagesearch.com/2018/08/13/opencv-people-counter/) or techniques that provide people counts as a side effect (example as a face detector: https:developers.google.com/ml-kit/vision/face-detection). It is noted that emotion detectors use face detection to map facial features to determine emotional state.

Additionally or alternatively to determination via analyzing video images, the system 1 may comprise one or more room occupancy detectors, such as infrared motion detectors, microwave (radar) motion detectors, an ultrasonic motion detectors, a tomographic motion detectors, and/or further cameras. Alternatively or additionally, the processing circuitry 5 may determine the room occupancy status by querying the meeting room's schedule on calendaring server 14, which may be used, e.g., when the system 1 is operated automatically by schedule.

In step 302, the processing circuitry 5 determines, if a change in the room occupancy occurred, i.e., whether the room occupancy status has changed from ‘occupied’ to ‘unoccupied’ or vice versa. The determination in step 302 is done by comparing the current room occupancy status, obtained in step 301 with a prior room occupancy status, stored in memory 18. In case the processing circuitry 5 just started its operation, the memory 18 may not comprise a prior room occupancy status and the result of the determination in step 302 is negative.

In case no change in room occupancy is determined in step 302 and in step 303, the current room occupancy status is stored in memory 18 as prior room occupancy status. The processing circuitry 5 then waits for a predefined polling interval (e.g., 10 seconds) in step 304 until the current room occupancy status is determined again in step 301.

If a change in room occupancy is determined in step 302, the processing circuitry 5 in step 305 detects whether user content, such as text, diagrams, or other writing is present on the whiteboard 16 using the video data of content camera 2b. To detect user content, the processing circuitry 5 is configured for object detection, again using the YOLO v3 object detection algorithm, which here is trained to discern between an empty whiteboard 16 and a whiteboard 16 with user content.

Alternatively or additionally, an automatic whiteboard detection method may be used. Corresponding methods are for example described in “Whiteboard Scanning and Image Enhancement”, Zhengyou Zhang, Li-wei He, Technical Report, June 2003, Microsoft Research (available at: http://citeseerx.ist.psu.edu/viewdoc/download?doi=10.1.1.2.8740&rep=rep1&type=pdf) and in “Automated Detection of Handwritten Whiteboard Content in Lecture Videos for Summarization”, Bhargava Urala Kota et al., 2018 16^{th} International Conference on Frontiers in Handwriting Recognition (available at: https://par.nsf.gov/servlets/purl/10113238).

In case no user content is detected on the whiteboard 16 in step 306, the operation reverts to step 303. No other action is necessary since the possibility of an unintended ‘leak’ of the potentially sensitive or confidential user content on whiteboard 16 is not given.

In case the processing circuitry 5 in step 306 detects the presence of user content, it is checked in step 307 if a clearance indicator is detected on the whiteboard 16. The presence of a clearance indicator provides that the user content has been left on the whiteboard 16 intentionally. Accordingly, a security notification may not be necessary in this case since it is assumed that the respective meeting participant determined that the whiteboard 16 does not contain sensitive or confidential information.

In some embodiments, the clearance indicator can be provided by a meeting participant by writing “do not erase” or “leave” on the whiteboard. The processing circuitry 5 in these embodiments is configured with an optical character recognition (OCR) algorithm to detect “do not erase” or “leave” on the whiteboard 16 from the video data of the content camera 2b.

In case the clearance indicator is detected in step 307, the operation of processing circuitry 5 reverts to step 303. In case no clearance indicator is detected, the operation of processing circuitry 5 continues to step 308.

In step 308, the processing circuitry 5 saves an image of the whiteboard 16 in memory 18. This allows to reconstitute the user content on whiteboard 16 at a later time and also allows logging the operation of the system 1.

In step 309, the processing circuitry 5 provides the security notification according to a predefined escalation schedule. The escalation schedule provides actions to be taken depending on how long user content is present on the whiteboard 16. An exemplary escalation schedule is provided below:

| Security | Time passed | |
|---|---|---|
| Notification | since user content | |
| Level | detected first [min] | Notification Action |
| 1 | 0 | Provide notification in meeting room 10 |
| 2 | 5 | Level 1 actions & provide notification on |
| | | outside consoles of video conferencing |
| | | system & notify meeting organizer |
| 3 | 10 | Level 2 actions with increased |
| | | notification frequency |
| 4 | 20 | Level 3 actions & notify facilities |
| | | management |
| 5 | 30 | Level 4 actions & remove room |
| | | reservations for current day & block new |
| | | room reservations |

In step 309, user content was recently detected on the whiteboard 16. Thus the level 1 security notification according to the preceding escalation schedule is provided, according to which the security notification is provided on the video screen 9 and played back intermittently on the speakers of system 1. In the present embodiment, the security notification provides: “WARNING!—content left on whiteboard—security leak possible—please remove.”

In addition, an escalation timer is started to determine the time that has passed since the user content was detected first. At last, the system 1 is controlled by the processing circuitry 5 to block the initiation of a video conference. The latter avoids remote leaks by temporarily prohibiting new video conferences to be started.

In step 310, it is again detected, if whiteboard 16 comprises user content. The operation in step 310 corresponds to the operation of step 305, discussed in the preceding. In step 311, based on the detection in step 310, it is checked, if the whiteboard 16 has been cleaned in the meantime or if a clearance indicator has been added. If this is the case and in step 312, the processing circuitry 5 stops providing the security notification, unblocks the initiation of video conferences, and stops the timer. The operation then reverts back to step 301, where the processing circuitry 5 detects the current room occupancy status.

In case the user content has not been removed from the whiteboard 16 and in step 313, it is determined, if a user override is present. The user override allows a local meeting participant, using touchpad controller 19 to manually override the security notification, for example in case the user content on the whiteboard 16 should not be sensitive/confidential or in case all participants of that meeting are trustworthy.

In case a user override has been entered on touchpad controller 19, the processing circuitry 5 in step 314 determines, whether any override settings have been predefined and stored in memory 18. For example, and depending on the policy of the organization, the override settings may comprise that a background blur filter is required for the outgoing video stream so that the whiteboard 16 cannot be seen. Alternatively or additionally, the override settings may comprise that the use of content camera 2b is restricted. If override settings are present in memory 18, the processing circuitry 5 programs the video conferencing system 1 accordingly.

Once any eventual override settings are applied, the operation proceeds to step 312, as discussed in the preceding.

In case in step 313, no user override has been detected, the operation of processing circuitry 5 continues with step 315. Here, the processing circuitry 5 checks, if the security notification level needs to be escalated. This is done by comparing the timer with the escalation schedule. For example, if 5 minutes or more have been passed since the user content has been detected first, an escalation is necessary (see preceding table). Consequently, the processing circuitry in step 316 applies the next security notification level, i.e., in this example security notification level 2, which provides to apply the security notification level 1 and in addition to provide the security notification on outside consoles of video conferencing system 1, if present. Furthermore, the organizer of the last meeting is notified that content was left on the whiteboard 16. The processing circuitry 5 determines the meeting organizer by querying calendaring server 14, which comprises the room's 10 schedule. The security notification is then provided to the determined meeting organizer using notification server 13, e.g., by e-mail or text message.

In case it is determined that security notification level 3 applies, the level 2 notification actions are provided with an increased notification frequency of the audio notification by the speakers and the notification of the meeting organizer using notification server 13. As discussed in the preceding, the security notification provided on video screen 9 is provided constantly.

In case it is determined that security notification level 4 applies, the level 4 notification actions are provided and in addition, the facilities (building) management is notified that the whiteboard 16 comprises user content that may need to be cleared using notification server 13. This message may, e.g., be repeated with an increasing frequency.

In case it is determined that security notification level 4 applies, the level 3 notification actions are provided. In addition, all reservations of the meeting room 10 for the remaining workday are deleted from the schedule on calendaring server 14. Furthermore, the meeting room 10 is set unbookable on calendaring server 14. Further security level escalations may for example comprise instructing the room control system 15 to switch off the lights in the meeting room 10, close blinds in the meeting room 10, turn smart glass windows in the meeting room 10 opaque, and/or lock the meeting room 10.

After step 316 is completed, the operation of the processing circuitry 5 reverts back to step 310. The operation of FIG. 3 is continued until the video conferencing system 1 is powered off.

While the exemplary embodiments of the present invention are described and illustrated herein, it will be appreciated that they are merely illustrative and that modifications can be made to these embodiments without departing from the spirit and scope of the invention. Acts described herein may be computer readable and executable instructions that can be implemented by one or more processors and stored on a computer readable memory or articles. The computer readable and executable instructions may include, for example, application programs, program modules, routines and subroutines, a thread of execution, and the like. In some instances, not all acts may be required to be implemented in a methodology described herein.

Terms such as “component”, “module”, “circuitry”, “unit”, and “system” are intended to encompass hardware, software, firmware, or any combination thereof. For example, a system or component may be a process, a process executing on a processor, or a processor. Furthermore, a functionality, component or system may be localized on a single device or distributed across several devices. The described subject matter may be implemented as an apparatus, a method, or article of manufacture using standard programming or engineering techniques to produce software, firmware, hardware, or any combination thereof to control one or more computing devices.

Thus, the scope of the invention is intended to be defined only in terms of the following claims as may be amended, with each claim being expressly incorporated into this description as an embodiment of the invention.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit may fulfill the functions of several items recited in the claims.

The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

What is claimed is:

1. A secure video conferencing system for a meeting room, comprising at least:
a camera for capturing video of at least one writing board in the meeting room and to provide video data thereof; and
processing circuitry, connected at least with the camera to receive the video data; wherein
the processing circuitry is configured to determine a change in room occupancy of the meeting room and to detect user content on the at least one writing board using the video data; and wherein
the processing circuitry is further configured to provide a security notification if upon the determination of the change in room occupancy, user content is present on the at least one writing board.

2. The secure video conferencing system of claim 1, wherein the processing circuitry is configured to provide the security notification until it is detected that the user content is removed from the at least one writing board.

3. The secure video conferencing system of claim 1, further comprising one or more of a video device and a speaker, wherein the security notification is provided in the meeting room with at least one of the video device and the speaker.

4. The secure video conferencing system of claim 1, further comprising a communication interface, connected with the processing circuitry and being connectable to a network, wherein the security notification is provided to one or more of a notification server, a calendaring server, and a room control system using the communication interface.

5. The secure video conferencing system of claim 1, wherein the processing circuitry is configured with a hierarchy information, so that processing circuitry provides the security notification in dependence of the hierarchy information.

6. The secure video conferencing system of claim 1, wherein the processing circuitry is configured with an escalation schedule, so that the processing circuitry provides the security notification in dependence of the escalation schedule.

7. The secure video conferencing system of claim 1, wherein the processing circuitry is further configured to block the initiation of a video conference when the security notification is provided.

8. The secure video conferencing system of claim 7, wherein the processing circuitry is configured so that an initiation of the video conference is possible by a user override while the security notification is provided.

9. The secure video conferencing system of claim 1, further comprising a memory interface, coupled with the processing circuitry, wherein in case the change in room occupancy is determined and user content is present on the at least one writing board, the memory interface is configured to store one or more images of the at least one writing board.

10. The secure video conferencing system of claim 9, further comprising a memory, coupled with the memory interface for storing the one or more images of the at least one writing board.

11. The secure video conferencing system of claim 1, wherein the processing circuitry is configured not to provide the security notification in case a clearance indicator is detected in the video data.

12. The secure video conferencing system of claim 1, wherein the change in room occupancy is determined by the processing circuitry using one or more of the camera and at least one room occupancy detector.

13. The secure video conferencing system of claim 1, wherein the processing circuitry is configured to determine the user content on the at least one writing board by object detection.

14. The video conferencing system of claim 1, wherein the processing circuitry is configured to determine the change in room occupancy by object detection.

15. The video conferencing system of claim 1, wherein the processing circuitry is configured to determine the change in room occupancy of the meeting room and to detect user content on the at least one writing board in predefined intervals.

16. Processing circuitry for a video conferencing system for a meeting room, wherein the processing circuitry is connectable at least with a camera of the video conferencing system to receive video data; wherein
the processing circuitry is configured to determine a change in room occupancy of the meeting room and to detect user content on at least one writing board in the meeting room using the video data; and wherein
the processing circuitry is further configured to provide a security notification if upon the determination of the change in room occupancy, user content is present on the at least one writing board.

17. A method of operating a secure video conferencing system for a meeting room, wherein the secure video conferencing system comprises at least a camera for capturing video of at least one writing board in the meeting room and to provide video data thereof; the method comprising the steps of:
determining, using the video data, a change in room occupancy of the meeting room;
detecting user content on the at least one writing board using the video data; and
providing a security notification if upon the determination of the change in room occupancy, user content is present on the at least one writing board.

18. A non-transitory computer-readable medium including contents that are configured to cause processing circuitry for a secure video conferencing system to conduct the method of claim 17.
